(19) United States
(12) Patent Application Publication
(10) Pub. No.: US 2010/0082317 A1
(43) Pub. Date: Apr. 1, 2010

(54) SEMICONDUCTOR DEVICE SIMULATION APPARATUS, COMPUTER READABLE MEDIUM STORING THEREON PROGRAM FOR CAUSING COMPUTER TO EXECUTE SEMICONDUCTOR DEVICE SIMULATION METHOD, AND SEMICONDUCTOR DEVICE SIMULATION METHOD

(76) Inventors: Takashi KURUSU, Yokohama-shi (JP); Hiroyoshi TANIMOTO, Yokohama-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/562,744

(22) Filed: Sep. 18, 2009

(30) Foreign Application Priority Data
Sep. 26, 2008 (JP) 2008-248326

(51) Int. Cl. G06F 17/50

(52) U.S. Cl. 703/13

(57) ABSTRACT

A semiconductor device simulation apparatus includes a first module configured to compute a reciprocal of the momentum relaxation time with respect to a part which is processed as an anisotropic scattering process of a carrier, and to compute the free-flight time by using the reciprocal of the momentum relaxation time, a second module configured to compute a drift process of the carrier during the free-flight time, and a third module configured to compute a scattering process by regarding a scattering a after of the drift process as an isotropic scattering, and by an output of the second module.

### CROSS-REFERENCE TO RELATED APPLICATIONS

This application is based upon and claims the benefit of priority from prior Japanese Patent Application No. 2008-248326, filed Sep. 26, 2008, the entire contents of which are incorporated herein by reference.

### BACKGROUND

Monte Carlo simulation for carrier transport analysis is a method which rigorously solve a Boltzmann transport equation, and is a method excellent in handling such a non-equilibrium carrier as a hot carrier (high energy carrier) occurring at a drain end of a Metal Oxide Semiconductor Field Effect Transistor (MOSFET) to which a high bias voltage is applied (see, for example, Jpn. Pat. Appln. KOKAI Publication No. 2006-113749). Thus, it is possible to predict a substrate current which becomes an index of reliability of a device, and evaluate or predict electrical characteristics of a small-scale MOSFETs.

### SUMMARY

A semiconductor device simulation apparatus according to one aspect of the present invention comprising a semiconductor device simulation apparatus comprising: a first module configured to compute a reciprocal of the momentum relaxation time with respect to a part which is processed as an anisotropic scattering process of a carrier, and to compute the free-flight time by using the reciprocal of the momentum relaxation time; a second module configured to compute a drift process of the carrier during the free-flight time; and a third module configured to compute a scattering process by regarding a scattering a after of the drift process as an isotropic scattering, and by an output of the second module.

A computer readable medium according to one aspect of the present invention having stored thereon a computer program which is executable by a computer in a semiconductor device simulation apparatus, the computer program controlling the computer to execute functions of: computing a reciprocal of the momentum relaxation time with respect to a part which is processed as an anisotropic scattering process of a carrier, and computing the free-flight time by using the reciprocal of the momentum relaxation time; computing a drift process of the carrier during the free-flight time; and computing a scattering process by regarding a scattering after the drift process as an isotropic scattering, and by an output of the computing the drift process.

A semiconductor device simulation method according to one aspect of the present invention comprising a semiconductor simulation method using a semiconductor device simulation apparatus including an input section, control section, and computation section configured to compute the free-flight time, computation section configured to compute a drift process, and computation section configured to compute a scattering process which are controlled by the control section, comprising: computing a reciprocal of the momentum relaxation time from an input value input from the input section with respect to a part which is processed as an anisotropic scattering process of a carrier, and computing the free-flight time by using the reciprocal of the momentum relaxation time; computing a drift process of the carrier during the free-flight time; and computing a scattering process by regarding a scattering after the drift process as an isotropic scattering, by an output of the computing the drift process.

### BRIEF DESCRIPTION OF THE DRAWING

FIG. 1 is a view showing a semiconductor device using a semiconductor device simulation method according to a first embodiment;

FIG. 2 is a flowchart showing the semiconductor device simulation method according to the first embodiment;

FIG. 3 is a view showing a relationship between the energy of a simulation electron and the number of times of scatterings with respect to the scattering frequency and momentum relaxation frequency;

FIG. 4 is a view showing a result obtained by executing a simulation of donor-type impurity concentration dependency of electron mobility by the semiconductor device simulation method according to the first embodiment;

FIG. 5 is a view showing an external appearance of a semiconductor device simulation apparatus according to a second embodiment;

FIG. 6 is a block diagram showing a configuration example of the semiconductor device simulation apparatus according to the second embodiment;

FIG. 7 is a block diagram for explaining a storage medium for storing a semiconductor device simulation program according to the second embodiment;

FIG. 8 is a view showing a semiconductor device using a semiconductor device simulation method according to a comparative example; and

FIG. 9 is a flowchart showing the semiconductor device simulation method according to the comparative example.

### DETAILED DESCRIPTION OF THE INVENTION

Here, the Monte Carlo simulation is superior in physical accuracy to a semiconductor device simulator equipped with a drift diffusion model normally used in a semiconductor device simulation. On the other hand, the computation time increase.

In the Monte Carlo simulation associated with semiconductor electron transport, the motion of an electron is described by repetition of a drift process, and scattering process. The computation drift process includes a process of solving a classical Newton's equation, and the computation of the scattering process includes a process of determining the type of scattering, and process of determining a wave number vector of an electron after scattering by using random numbers. When the scattering process is of isotropic scattering, it is easily possible to compute the wave number after the scattering by using uniform random numbers. However, when the scattering process is of anisotropic scattering like the Coulomb scattering, there is an aspect in which the labor configured to compute the wave number after the scattering by using the random numbers increase, and it becomes difficult to implement the wave number in the program. Although there is an anisotropic scattering mechanism with the similar property other than the Coulomb scattering, in that case too, however, there is the same tendency as the above.

Thus, an embodiment according to the present invention will be described below with reference to the accompanying drawings. In the description, throughout all the drawings, the common parts are denoted by the common reference symbols or numerals.

### First Embodiment

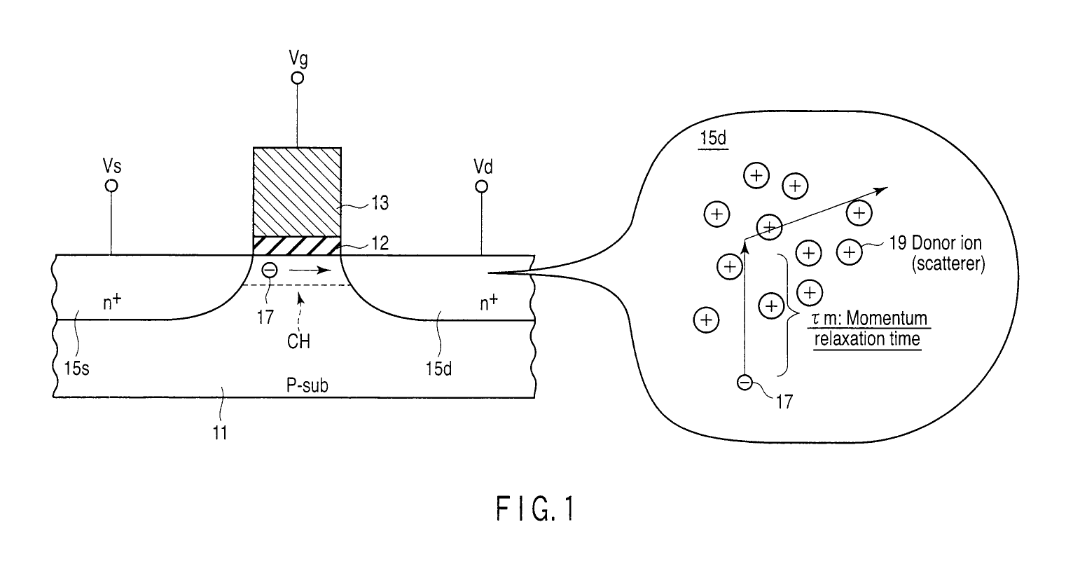

A semiconductor device simulation method according to a first embodiment will be described below by using FIGS. 1 to 4.

### 1-1. Semiconductor Device

First, a semiconductor device to which the semiconductor device simulation method according to the first embodiment is applied will be described below by using FIG. 1.

As shown in FIG. 1, the semiconductor device to which the semiconductor device simulation method according to this example is to be applied is an n-type gate-insulating Metal Oxide Semiconductor Field Effect Transistor (MOSFET).

A transistor is arranged in the device region, and is provided with a gate insulator 12 provided on a p-type semiconductor substrate 11, gate electrode 13 provided on the gate insulator 12, and source 15s and drain 15d provided in the semiconductor substrate 11 separately from each other in such a manner that the gate electrode 13 is interposed between the source 15s and drain 15d.

The gate insulator 12 is formed of a silicon dioxide film (SiO₂) or the like by, for example, a thermal oxidation method.

The gate electrode 13 is formed of, for example, poly-Si or the like. The gate electrode 13 is given a gate voltage Vg.

The drain 15d (n+) is formed by introducing n-type impurities such as arsenic (As) and antimony (Sb) into the semiconductor substrate 11 by, for example, the ion implantation method, and subjecting the impurities to thermal diffusion. The introduced n-type impurities release a free electron 17 which becomes a carrier, and become positively charged donor ions (scatterers) 19. Further, the drain 15d is given a drain voltage Vd.

The source 15s (n+) is formed, in the manner similar to the drain 15d, by introducing n-type impurities such as phosphorus (P) into the semiconductor substrate 11 by, for example, the ion implantation method, and subjecting the impurities to thermal diffusion. The introduced n-type impurities release a free electron 17 which becomes a carrier, and become positively charged donor ions (scatterers) 19. Further, the source 15s is given a source voltage Vs (Vd) smaller than the drain voltage Vd.

### Switching Operation of Transistor

In the configuration described above, when the source voltage Vs, drain voltage Vd, and predetermined positive gate voltage Vg are given, an electron 17 which is a carrier moves in the channel CH formed in the semiconductor substrate 11 under the gate electrode 13, whereby a current flows between the source 15s and drain 15d. By controlling the conduction/non-conduction of the current pathway of the carrier electron 17 in the manner described above, a switching operation of the transistor is carried out.

At the time of the switching operation, in the drain 15d which is the high concentration impurity region, the concentration of the ionized impurities 19 which become the scatterers is high, and hence the scattering frequency of the ionized impurity scattering becomes very high. Further, the scattering at this time is an anisotropic scattering process (forward scattering).

When the Monte Carlo simulation is carried out with respect to such a transistor, it is indispensable to take the source 15s/drain 15d region into consideration. However, in such a region of high impurity concentration, there are a large number of ionized impurities 19 which are scatterers, and hence scattering of the electron 17 occurs very frequently. This implies that the number of times of scatterings is large, and a very long computation time is required.

However, according to the semiconductor device simulation method using the Monte Carlo simulation to be described later in this example, computation is carried out not by using the scattering time τ used in the comparative example, but by using the momentum relaxation time τM. This makes it possible to reduce the effective number of times of scatterings, and computation time even in the case of the source 15s and drain 15d and the like in which the number of times of scatterings is large, and which require a long computation time. As a result of this, the above method is advantageous in the point that the computation cost can be reduced.

It should be noted that although here the p-type semiconductor substrate (p-sub) has been described as an example, a p-type semiconductor region (p-well) formed by introducing p-type impurities into a semiconductor substrate such as silicon (Si) may also be used. Further, here, illustration of other configurations such as Shallow Trench Isolation (STI) formed by being embedded in the semiconductor substrate 11 of the device isolation region, spacer to be provided along the sidewall of the gate electrode 13, interlayer dielectric provided to cover the top surface of the transistor, and the like is omitted.

### 1-2. Semiconductor Device Simulation Method

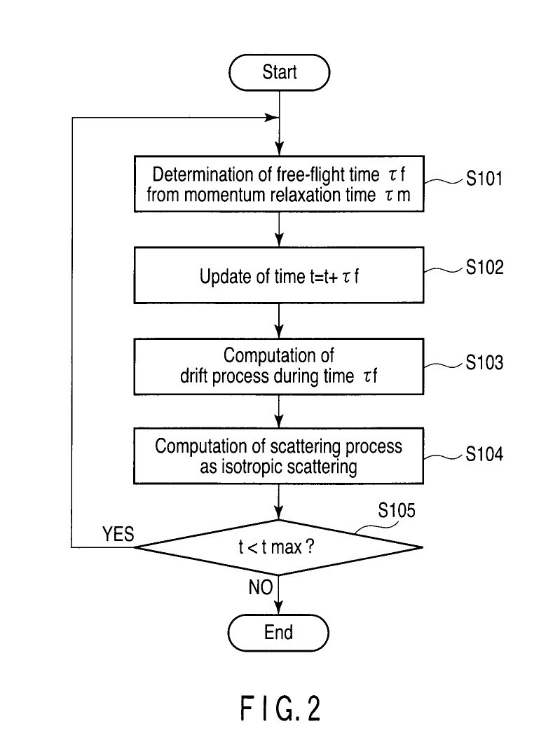

Next, the semiconductor device simulation method according to this example will be described below by using FIGS. 2 to 5. In this description, the single-particle Monte Carlo simulation in which ionized impurity scattering is taken into consideration is used and, as the ionized impurity scattering, the Conwell-Weisskopf model is used as an example. The description will be given below in accordance with the flow shown in FIG. 2.

### (Step S101)

First, the free-flight time τf is determined from the momentum relaxation time τm. As in this step S101, this example differs from the comparative example to be described later in the point that at the time of determining the free-flight time τf, the scattering time τ according to the comparative example to be described later is not used, and the momentum relaxation time τm is used.

The free-flight time τf implies the time within which a carrier (for example, a carrier electron 17) moves without being scattered. It is possible to theoretically compute the scattering time τ as a function of the type (acoustic phonon scattering, optical phonon scattering, ionized impurity scattering, electron-electron scattering, and the like) of scattering of the carrier, and carrier energy. Considering the motion of a carrier, there is the time between scattering and scattering. During the time between scattering and scattering, the carrier is not scattered, and travels while being accelerated by the electric field. The travel in the non-scattered state is called the free flight. As for the free-flight time, although the average value thereof is the scattering time τ, the carrier is not always scattered at intervals of τ, and the carrier is scattered in the time shorter than τ or longer than τ conversely.

Here, in the comparative example, the number of times of scatterings is obtained by computing the scattering frequency (the number of times the carrier is scatted by the scatterers per unit time), then the scattering time τ is obtained, and the free-flight time τf is determined by using the scattering time τ and random numbers. That is, the scattering time τ is expressed by the following formula (1).

$$1 / τ = {\sum }_{{k}^{′}} P ( k , {k}^{′} ) \qquad formula ( 1 )$$

In the formula (1), P (k, k′) is the transition probability (the number of times the transition occurs per unit time) of the state being changed from a state k to state k′.

On the other hand, in step S101 according to this example, this example differs from the comparative example in the point that the momentum relaxation frequency 1/τm which is a reciprocal of the momentum relaxation time τm is used in place of the scattering frequency 1/τ. The momentum relaxation frequency 1/τm is expressed by the following formula (2).

$$1 / {τ}_{m} = {\sum }_{{k}^{′}} \frac{( k - {k}^{′} ) \cdot k}{k \cdot k} \cdot P ( k , {k}^{′} ) \qquad formula ( 2 )$$

As expressed by the above formula (2), the reciprocal of the momentum relaxation time τM is obtained by multiplying the transition probability P (k,k′) by the rate of change in the momentum of the carrier [(k−k′)·k/k·k] as the weight, and by acquiring the sum total (Σ) of the above value with respect to the final state (wave number after the scattering) k′.

As a result of this, the momentum relaxation time τm is defined as the reciprocal of the above formula (2).

For example, when the scattering frequency 1/τ, and momentum relaxation frequency 1/τm are computed by using a Conwell-Weisskopf model obtained by modeling the ionized impurity scattering configured as shown in FIG. 1, these are expressed by the following formulas (3) and (4).

$$\begin{matrix}\frac{1}{τ ( {E}_{k} )} = \frac{π}{4} {{N}_{i}^{1 / 3} ( \frac{2 {E}_{k}}{{m}^{*}} )}^{1 / 2} & formula ( 3 ) \\ \frac{1}{{τ}_{m} ( {E}_{k} )} = π {{N}_{i} ( \frac{{E}_{k}}{2 {m}^{*}} )}^{1 / 2} {( \frac{Z {e}^{2}}{4 {πɛ}_{s} {E}_{k}} )}^{2} ln [ 1 + {( \frac{4 π {ɛ}_{s} {E}_{k}}{{N}_{i}^{1. / 3} Z {e}^{2}} )}^{2} ] & formula ( 4 )\end{matrix}$$

In the formulas (3) and (4), Eₖ is the carrier energy, Nᵢ is impurity density, εₛ is dielectric constant of the material, and m* is effective mass. Comparison between scattering frequency 1/τ and momentum relaxation frequency 1/τm.

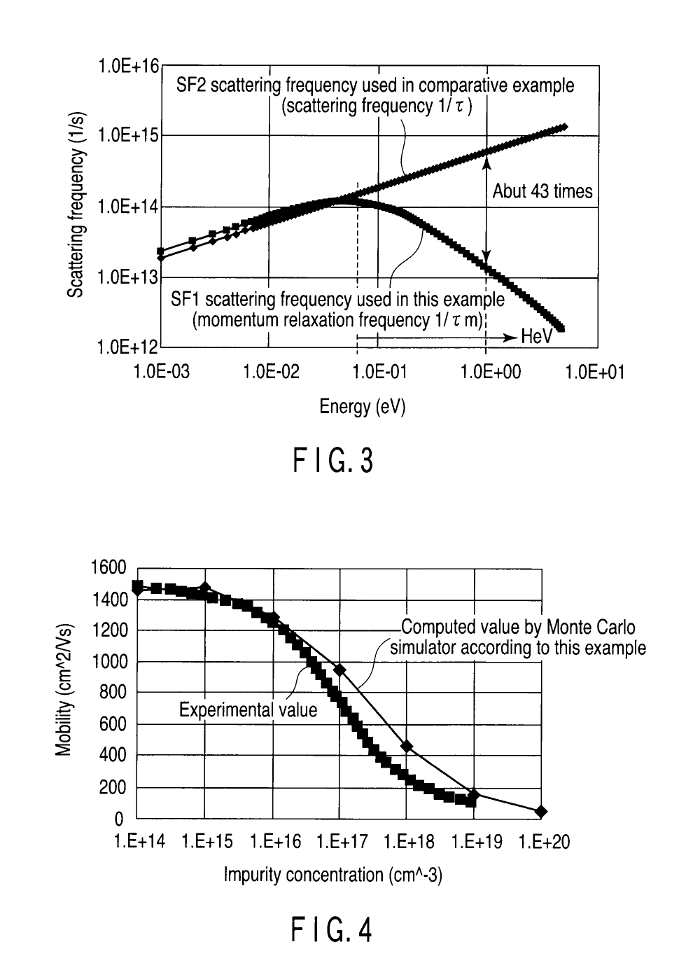

Here, the result of comparing the scattering frequency 1/τ and momentum relaxation frequency 1/τm with each other with respect to the respective impurity concentrations will be described by using FIG. 3. FIG. 3 shows the relationship between the energy (eV) of the simulation electron and scattering frequency (1/s) with respect to the scattering frequency 1/τ and momentum relaxation frequency 1/τm.

As shown in FIG. 3, when the scattering frequency 1/τ and momentum relaxation frequency 1/τm are compared with each other, in the low energy region up to about 20 meV, both of them exhibit values of substantially the same level. On the other hand, in the high energy region of 20 meV or higher, it can be seen that the value of the momentum relaxation frequency 1/τm becomes obviously lower. This indicates that the scattering of the ionized impurities 19 is the forward scattering in which the scattering angle becomes small at the high energy, and hence the momentum relaxation occurring in one scattering is small in spite of the large number of scatterings.

For example, the scattering frequency (number of scatterings) SF2 according to the comparative example is larger than the scattering frequency SF1 according to this example by a difference of about 43 times with respect to the carrier with substantially the same energy of about 1 eV. That is, in this case, this implies that it is possible, in the scattering frequency SF1 according to this example, to reduce the number of times of scatterings to about 1/43 as compared with the scattering frequency SF2 according to the comparative example. In other words, the above implies that it is possible to replace repetitive scatterings of some dozen times with a small scattering angle with one scattering.

In this example, this fact is utilized. In the method according to the comparative example, only after scatterings of a small scattering angle (scatterings in which a change in angle of the direction of travel is small between the states before and after scattering) occur a large number of times, the momentum relaxation occurs, this requiring so much processing.

Thus, in this example, in place of the above, scattering takes place in step S101 only after an elapse of the momentum relaxation time τM. Further, in step S104 which will be described later, there is a step in which in the state after the scattering, the momentum is made the random momentum (isotropic scattering).

### (Step S102)

Subsequently, in step S102, the time (t=t+τf) after the free flight is computed.

### (Step S103)

Subsequently, in step S103, computation of the drift process during the time τf is carried out. The drift process implies a process in which the carrier is accelerated by the electric field to be moved in the non-scattered state.

### (Step S104)

Subsequently, in step S104, computation of the scattering process is carried out by regarding the computed drift process as isotropic scattering. Here, the computation of the scattering process is constituted of computation of determination of the type of scattering (acoustic phonon scattering, optical phonon scattering, ionized impurity scattering, and the like), and computation of determination of the wave number after the scattering. The determination of the type of scattering implies a process of determining the type of scattering process which will occur, e.g., determining whether the scatterer is the phonon or ionized impurities. In the method for determining the type of scattering, the scattering frequency indicating the number of times the carrier receives scatterings per unit time depending on the type of scattering is computed in advance with respect to all the scattering mechanisms, and the type of scattering is determined in such a manner that the scattering occurs stochastically in proportion to the frequency by using the random numbers. The wave number after the scattering implies that the carrier travelling in a certain direction is changed in direction of travel by the scattering, i.e., the direction of travel of the carrier is changed by the scattering. The wave number after the scattering is also determined by using the random numbers.

In step S104 according to this example, at the time of computing the scattering process, the wave number after the scattering is computed by regarding the scattering process which is originally of the anisotropic scattering as an isotropic scattering process.

### (Step S105)

Subsequently, in step S105, determination by comparing the sizes of the time t after the free flight, and designated time tmax with each other is carried out (t<tmax?).

As a result of the determination, when the designated time tmax is not reached (YES), the processing from the determination of the free-flight time τf (step S101) to the computation of the scattering process (step S104) is carried out again.

On the other hand, as a result of the determination, when the designated time tmax is reached (NO), the semiconductor simulation method is terminated (END).

Comparison with Experimental Value

Next, the comparison between the computed value and experimental value to be carried out by using the semiconductor device simulation method according to this example will be described below by using FIG. 4. FIG. 4 shows a result of executing a simulation of donor-type impurity concentration dependency of electron mobility in the n-type silicon at 300K by the semiconductor device simulation method according to this example.

As shown in FIG. 4, it can be seen that the computed value obtained by the semiconductor device simulation method according to this example, and the actual measurement value of the electron mobility substantially coincide with each other, and the actual measurement value can be substantially reproduced. Accordingly, the computation executed by the semiconductor device simulation method according to this example is appropriate from the viewpoint of computation accuracy.

It should be noted that what has been described above in the first embodiment is the most simplified single-particle Monte Carlo simulation. However, the description in the first embodiment is not limited to this. The first embodiment can also be applied to the Monte Carlo simulation ensemble, and the same advantage can be obtained. The detailed description of this is omitted here.

According to the device simulation method associated with the first embodiment, at least the advantages of the following items (1) and/or (2) may be obtained.

(1) Advantage in Reduction of Computation Cost

As described above, according to the semiconductor device simulation method of the first embodiment, with respect to the part for processing at least the anisotropic scattering process, step (S101) of computing the reciprocal of the momentum relaxation time, and computing the free-flight time by using the reciprocal of the momentum relaxation time 1/τm, and step (S104) of computing the scattering process by regarding the scattering after the drift process as the isotropic scattering are carried out.

At the time of step S101 described above, by using the reciprocal of the momentum relaxation time 1/τm as the scattering frequency, it is possible to reduce the effective number of times of scatterings (to lower the scattering frequency), and compute the scattering time longer.

Further, at the time of step S104 described above, by regarding the scattering as the isotropic scattering, it is possible to evaluate the electric characteristics at a high speed.

Accordingly, it is possible to reduce the average number of times of scatterings, and reduce the computation time. Thus, step S104 is advantageous to reduction in computation cost.

For example, as shown in FIG. 3, the scattering frequency (number scatterings) SF2 according to the comparative example is larger than the scattering frequency SF1 according to this example by a difference of about 43 times with respect to the carrier with substantially the same energy of about 1 eV. That is, in this case, it is possible, in the scattering frequency SF1 according to this example, to reduce the number of times of scatterings to about 1/43 as compared with the scattering frequency SF2 according to the comparative example. In other words, the above implies that it is possible to replace repetitive scatterings of some dozen times with a small scattering angle with one scattering.

Further, when the average value of the momentum to be relaxed per unit time is considered, the value obtained by the computation according to this example, and the value obtained by the computation according the comparative example are equal to each other. This implies that the carrier mobility computed by using the semiconductor device simulation method according to this example is substantially equal to the mobility computed by using the semiconductor device simulation method according to the comparative example.

(2) Capability of Improving Simulation Efficiency without Lowering Reliability

As shown in FIG. 4, it can be seen that the computed value obtained by the semiconductor device simulation method according to this example, and the actual measurement value of the electron mobility substantially coincide with each other, and the actual measurement value can be substantially reproduced. Accordingly, in the computation executed by the semiconductor device simulation method according to this example, the computation accuracy is not lowered from the viewpoint of computation accuracy in the mobility. Thus, the device simulation method according to the first embodiment is advantages in the point that efficient simulation is enabled without lowering the reliability.

### Second Embodiment

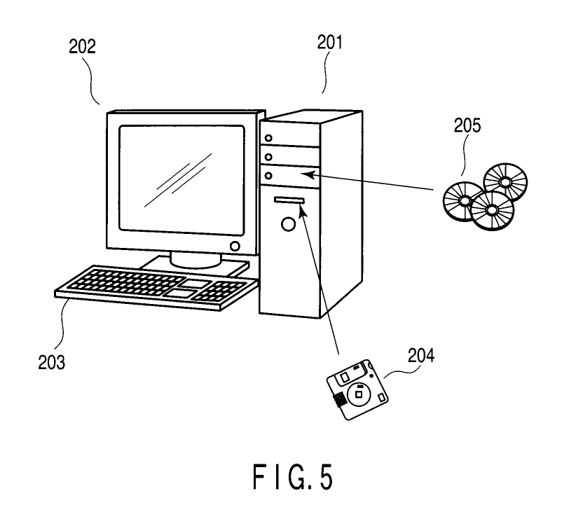

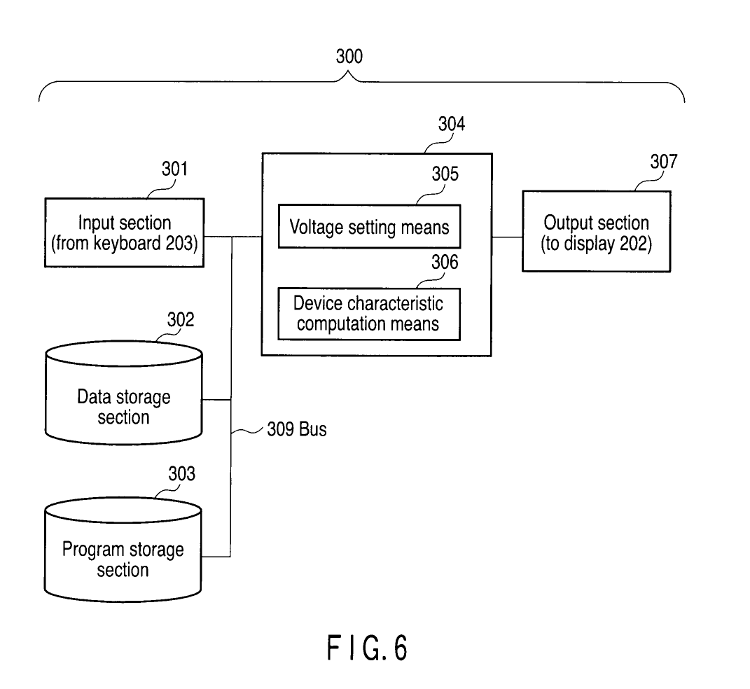

Next, a second embodiment will be described below by using FIGS. 5 and 6. The second embodiment relates to a semiconductor device simulation apparatus (semiconductor device simulator) for executing the semiconductor device simulation method according to the first embodiment.

In this description, detailed description of parts overlapping the first embodiment will be omitted. Regarding external appearance of semiconductor device simulation apparatus

First, the external appearance of the semiconductor device simulation apparatus will be described below by using FIG. 5.

As shown in FIG. 5, the semiconductor device simulation method according to the first embodiment can be realized as a program operating on an ordinary computer. In this case too, it is possible to shorten the computation time without sacrificing the computation accuracy as described previously.

The external appearance of the semiconductor simulation apparatus in which device simulation is realized by hardware is shown in FIG. 5. In this example, a computer PC will be described as an example of the semiconductor simulation apparatus.

The semiconductor simulation apparatus according to this example is provided with, as the external appearance thereof, a computer main body 201, display 202, and keyboard 203.

The computer main body 201 controls the overall semiconductor simulation apparatus. The computer main body 201 includes a floppy disk drive, optical disk drive, and the like. A floppy disk 204 can be inserted into the floppy disk drive, and a CD-ROM 205 can be inserted into the optical disk drive. It is possible to store the program and the like for executing the semiconductor simulation method according to the first embodiment in a storage medium such as the floppy disk 204, CD-ROM 205, and the like. The computer main body 201 can install the stored program inside the main body 201.

Further, it is possible to use a magnetic tape unit by connecting a predetermined drive to the computer main body 201.

The display 202 is connected to the computer main body 201, and graphically displays editing, simulation results, and the like.

The keyboard 203 is also connected to the computer main body 201, and can operate editing of condition input to the program according to the installed semiconductor simulation method, and reading and the like of the simulation results.

### Regarding Configuration Example of Semiconductor Device Simulation Apparatus

Next, a configuration example of the semiconductor device simulation apparatus will be described below by using FIG. 6.

As shown in FIG. 6, the configuration 300 of the semiconductor device simulation apparatus according to this example is, for example, that mounted on the computer main body 201 in FIG. 5.

The semiconductor device simulation apparatus is provided with an input section 301, data storage section 302, program storage section 303, processing control section 304, and output section 307.

The input section 301 is connected to a bus 309, and for example, a condition for the program according to the semiconductor simulation method input from the keyboard 203, and data of the simulation result, and the like are input thereto.

The data storage section 302 is connected to the bus 309, and various data, for example, management data, and the like are stored therein.

The program storage section 303 is connected to the bus 309, and a simulation program for executing the semiconductor simulation method (S101 to 5105) according to the first embodiment is stored therein.

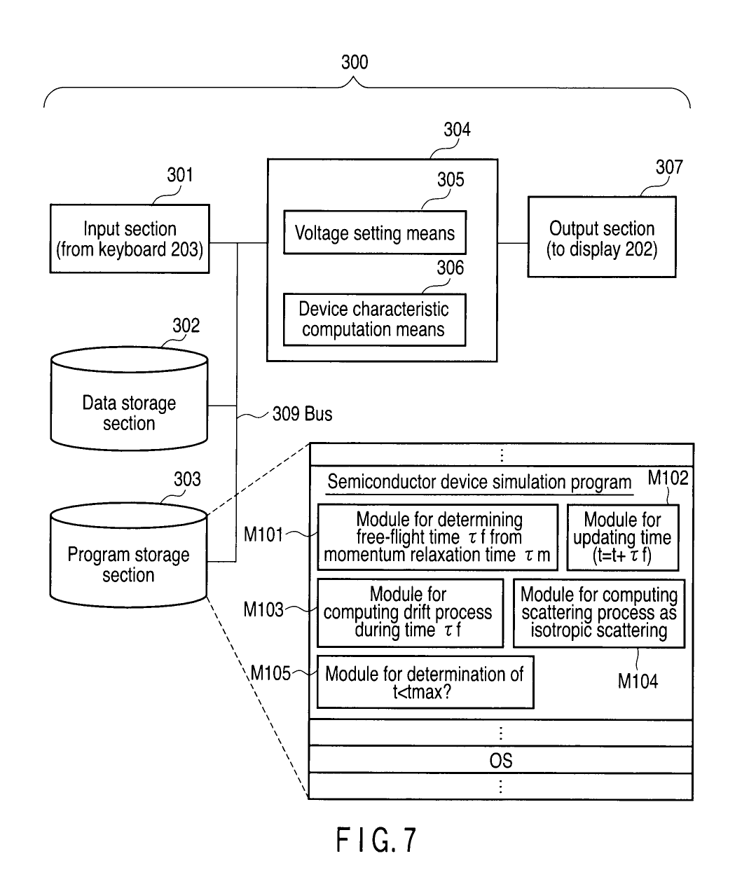

The program storage section (storage medium) 303 in which the semiconductor simulation program is stored is shown as, for example, FIG. 7.

As shown in FIG. 7, in the program storage section 303, for example, an operating system (OS) which is loaded from a hard disk drive (HDD) or the like, and is to be executed by the computer main body 201, and the semiconductor simulation program for executing the semiconductor simulation method (S101 to 5105) according to the first embodiment are temporarily stored. The operating system (OS), and semiconductor simulation program are executed by the processing control section, such as a CPU or the like.

The semiconductor simulation program is provided with a determination module M101 for determining the free-flight time τf from the momentum relaxation time τm, time update (t=t+τf) module M102, computation module M103 configured to compute the drift process during the time τf, computation module M104 configured to compute the scattering process as the isotropic scattering, and determination module M105 for determination by the comparison of the sizes (t<tmax?). By carrying out steps S101 to S105 of the semiconductor simulation method, the computer main body 201 is caused to execute the above modules M101 to M105.

It should be noted that even in the case where the semiconductor simulation method according to the first embodiment is installed from a storage medium such as the floppy disk 204, CD-ROM 205 or the like, the semiconductor simulation program is stored in the program storage section 303, and the same advantage can be obtained.

The processing control section 304 is electrically connected to the bus 309 and output section 307, and performs the control of the overall apparatus. The processing control section 304 includes voltage setting means 305 and device characteristic computation means 306.

The voltage setting means (voltage setting section) 305 carries out voltage setting of the semiconductor device in accordance with an input designated by the input section 301.

The device characteristic computation means (device characteristic computation section) 306 executes the simulation program according to the semiconductor simulation method described in the first embodiment by using the set voltage, input condition, and the like, and computes the semiconductor device characteristics.

The output section 307 is connected to the processing control section 304, and outputs the output of the processing control section 304 onto a display 202.

As described above, according to the device simulation apparatus associated with this embodiment, at least the same advantages as the above items (1) and (2) are obtained.

Furthermore, according to this example, at least an advantage shown in the following item (3) is further obtained.

### (3) Facility of Implementation of Program in Semiconductor Simulation Apparatus

Here, as will be described in the comparison example to be described later, in the case of an anisotropic scattering of the carrier transport analysis or the like, the computation procedure for obtaining the wave number after the scattering by using the random numbers is complicated, and hence it is difficult to realize a program for executing the semiconductor simulation method thereof. Accordingly, it also becomes difficult to implement such a program in the semiconductor simulation apparatus.

However, as described in the first embodiment, in the semiconductor simulation method according to this example, it is possible to reduce the average number of times of scatterings, and reduce the computation time. As a result of this, it is possible to facilitate the computation procedure, and hence it is easy to realize a program for executing the semiconductor simulation method. Accordingly, the semiconductor simulation method is advantageous in the point that it is easy to implement such a program in the semiconductor simulation apparatus.

For example, in the case of the configuration according to this example, the simulation program according to the semiconductor simulation method described in the first embodiment is stored in the program storage section 303. Further, it is also possible to store the program and the like for executing the semiconductor simulation method according to the first embodiment in a storage medium such as the floppy disk 204, CD-ROM 205 or the like. The computer main body 201 can install the stored program inside the main body 201.

As described above, it is possible to apply the configuration according to the second embodiment as the need arises.

### Comparative Example

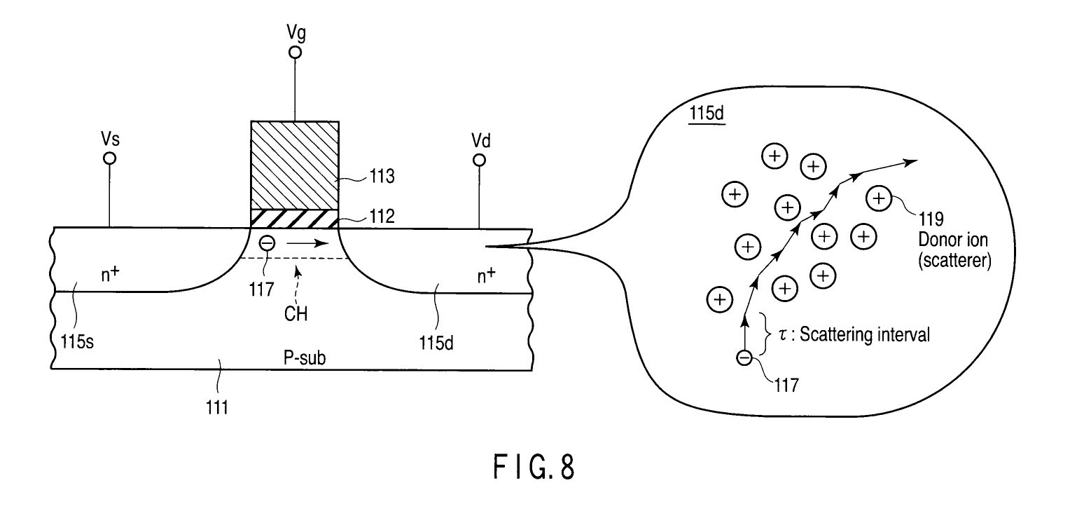

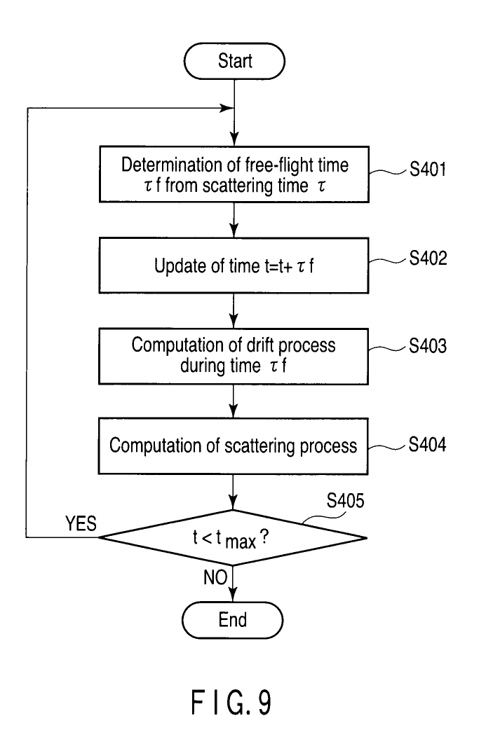

Next, a semiconductor device simulation method according to a comparative example for comparison with the first and second embodiments will be described below by using FIGS. 8 and 9. The comparative example relates to an example in which computation is carried out on the basis of the scattering interval in the Monte Carlo simulation. In the description, detailed description of parts overlapping the first embodiment will be omitted. It should be noted that this comparative example is an embodiment for clarifying the point thereof different from the first and second embodiments in comparison with the first and second embodiments, and shows the knowledge acquired by the inventor of the present invention in the process of contriving the present invention.

### Regarding Semiconductor Device

First, a semiconductor device to which a semiconductor device simulation method according to the comparative example is to be applied will be described below by using FIG. 8. As shown in FIG. 8, the semiconductor device to which the semiconductor device simulation method according to this comparative example is to be applied is an n-type gate-insulating metal oxide semiconductor field effect transistor.

As shown in the vicinity of a drain 115d, the comparative example differs from a comparative example to be described later in using the scattering time t of a carrier electron 117 due to donor ions (scatterers) 119 when the free-flight time τf is determined.

Accordingly, the number of scatterings (scattering frequency) increase, and the scattering time becomes short, whereby the computation time increase. As a result of this, the semiconductor device simulation method according to this comparative example is disadvantageous to reduction of the computation cost.

The semiconductor simulation method will be described below more specifically.

The semiconductor device simulation method according to the comparative example will be described below in accordance with FIG. 9. Here, the single-particle Monte Carlo simulation will be described. The Monte Carlo simulation is a simulation method configured to compute the motion of the carrier by handling the carrier as a particle, and alternately repeating the drift process and scattering process of the particle.

### (Step S401)

First of all, in step S401, the free-flight time τf which is the time within which the carrier moves without being scattered is computed.

It is possible to theoretically compute the scattering time τ as a function of the type (acoustic phonon scattering, optical phonon scattering, ionized impurity scattering, electron-electron scattering, and the like) of scattering of the carrier, and carrier energy. Considering the motion of a carrier, there is the time between a scattering and scattering. During the time between the scattering and scattering, the carrier is not scattered, and travels while being accelerated by the electric field. The travel in the non-scattered state is called the free flight. As for the free-flight time, although the average value thereof is the scattering time τ, the carrier is not always scattered at intervals of τ, and the carrier is scattered in the time shorter than τ or longer than τ conversely. The free-flight time can be determined by using uniform random numbers, this being step S401.

The scattering time τ can be obtained by the previously described formula (1).

### (Step S402)

Subsequently, in step S402, the time after the free flight is computed.

### (Step S403)

Subsequently, in step S403, computation of the drift process during the time τf is carried out. The drift process implies a process in which the carrier is accelerated by the electric field to be moved in the non-scattered state.

### (Step S404)

Subsequently, in step S404, computation of the scattering process is carried out. The computation of the scattering process is constituted of computation of determination of the type of scattering (acoustic phonon scattering, optical phonon scattering, ionized impurity scattering, and the like), and computation of determination of the wave number after the scattering. The determination of the type of scattering implies a process of determining the type of scattering process which will occur, e.g., determining whether the scatterer is the phonon or ionized impurities. In the method for determining the type of scattering, the scattering frequency indicating the number of times the carrier receives scatterings per unit time depending on the type of scattering is computed in advance with respect to all the scattering mechanisms, and the type of scattering is determined in such a manner that the scattering occurs stochastically in proportion to the frequency by using the random numbers. The wave number after the scattering implies that the carrier travelling in a certain direction is changed in direction of travel by the scattering, i.e., the direction of travel of the carrier is changed by the scattering. The wave number after the scattering is also determined by using the random numbers.

### (Step S405)

Subsequently, in step S405, determination by comparing the sizes of the time t after the free flight, and designated time tmax with each other is carried out. At this time, when the designated time is not reached (YES), the processing from the determination of the free-flight time τf (step S401) to the computation of the scattering process (step S404) is repeated. On the other hand, at this time, when the designated time is reached (NO), the semiconductor simulation method according to the comparative example is terminated.

As described above, in the Monte Carlo simulation according to the comparative example, it is necessary to repeat many times a part for solving the motion equation of the drift motion, and a part configured to compute the state after the scattering (wave number after the scattering). The computation time necessary for executing the Monte Carlo simulation is substantially equal to a value obtained by multiplying the sum of the computation time necessary for the part for solving the equation of motion during drift, and computation time for the part configured to compute the state after the scattering (wave number after the scattering) by the number of scatterings of the carrier. That is, in order to shorten the computation time, it is enough just to reduce the number of scatterings. Conversely, when the number of scatterings is large, the computation time becomes long.

Here, the ionized impurity scattering which is a scattering resulting from the Coulomb interaction between the carrier and ionized impurities will be considered as the scattering process. As is known well, in the ionized impurity scattering, there are the following tendencies.

(I) The scattering frequency becomes very high in a high concentration region such as the source/drain region.

(II) The ionized impurity scattering is an anisotropic scattering process (forward scattering).

When the Monte Carlo simulation is carried out with respect to the MOSFET according to the comparative example, it is indispensable to take the source 15s/drain 15d region into consideration. However, in such a region of high impurity concentration, there are a large number of ionized impurities 19 which are scatterers, and hence the scattering of the carrier occurs very frequently. This implies that the number of times of scatterings is large, and a very long computation time is required.

Further, there are two types of scattering processes, i.e., a scattering process in which the wave number after the scattering of the carrier (direction of travel of the carrier after the scattering) does not depend on the wave number before the scattering, and a scattering process in which the wave number after the scattering of the carrier depends on the wave number before the scattering. The former is called an isotropic scattering, and the latter is called a non-isotropic scattering (or anisotropic scattering). For example, the acoustic phonon scattering is an example of the isotropic scattering. On the other hand, the ionized impurity scattering is an example of the anisotropic scattering, and it is known that in the case of a high-energy carrier, the ionized impurity scattering is the forward scattering in which the probability that the direction of travel after the scattering changes substantially little from the direction of travel before the scattering is high.

In the case of the isotropic scattering, it is possible to easily compute the wave number after the scattering by using the uniform random numbers. On the other hand, in the case of the anisotropic scattering, the computation procedure for obtaining the wave number after the scattering by using the random numbers is complicated, and it is difficult to implement the procedure in the program.

As described above, according to the device simulation method associated with the comparative example, the device simulation method differs from the above-mentioned embodiments in the point that step (S401) of computing the free-flight time by computing the reciprocal of the scattering time τ, and using the reciprocal 1/τ of the scattering time τ, and step (S404) of computing the scattering process without regarding the wave number after the scattering as the isotropic scattering are carried out therein. As a result of this, at the time of step S401, the number of times of scatterings (scattering frequency) increase, and the scattering time becomes short, whereby the computation time increase.

At the time of step S404, the scattering is not regarded as the isotropic scattering, and hence it is not possible to evaluate the electric characteristics at a high speed.

Accordingly, the number of times of scatterings increase, and the computation time increase. Thus, the device simulation method according to the comparative example is disadvantageous to reduction of the computation cost.

It should be noted that in the above description, the ionized impurity scattering has been mentioned as an example of the anisotropic scattering. However, the application of the present invention is not limited to this. For example, there is an anisotropic scattering mechanism with the similar other properties such as elastic scattering, and the like, and the same tendency is obtained with respect to this. When the semiconductor device simulation method according to this example, and semiconductor device simulation apparatus for executing the method are applied to the elastic scattering, a high-speed simulation is enabled without sacrificing not only the mobility computation accuracy, but also the energy computation accuracy.

Furthermore, although the MOSFET with the source/drain region which is the high concentration impurity diffusion region has been mentioned above as an example of the semiconductor device, the example is not limited to this. For example, even in the case of a high voltage transistor arranged in the peripheral region of a memory cell array such as a NAND flash memory, the present invention can also be applied thereto, and the same advantage can be obtained. This is because the impurity concentration of the diffusion layer of the high voltage transistor tends to be higher than the impurity concentration of the diffusion layer of a memory cell in the memory cell array. Further, concomitantly with the micronization and increase in capacity, the number of the peripheral transistors also tends to increase. Needless to say, it is effective to apply the semiconductor device simulation method and semiconductor device simulation apparatus for executing the method to such a tendency.

Further, the carrier transport simulation in the semiconductor device has been described above. However, the present invention is not limited to this. For example, even in the case of carrier transport (electron transport) within metal, and the case where the particle is not an electron or the like, it is possible to apply the invention as the need arises. For example, in the metal, like the case of the carrier transport in the semiconductor, an electron receives a phonon scattering, impurity scattering or electron-electron scattering, and travels inside the metal. The scattering process includes an isotropic case, and anisotropic case, and the present invention can be applied to the scattering process of the latter. Further, in the case of a simulation model in which the carrier is handled as a particle, which includes a computation step of the scattering process, and requires processing of an anisotropic scattering process, the present invention can also be applied thereto.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A semiconductor device simulation apparatus comprising:
a first module configured to compute a reciprocal of the momentum relaxation time with respect to a part which is processed as an anisotropic scattering process of a carrier, and to compute the free-flight time by using the reciprocal of the momentum relaxation time;
a second module configured to compute a drift process of the carrier during the free-flight time; and
a third module configured to compute a scattering process by regarding a scattering a after of the drift process as an isotropic scattering, and by an output of the second module.

2. The apparatus of claim 1, further comprising a fourth module configured to compute the time after the free-flight time.

3. The apparatus of claim 1, further comprising:
a control section configured to control the first, second, and third modules; and
an input section and output section which are electrically connected to the control section.

4. The apparatus of claim 3, further comprising a data storage section an output of which is connected to the input section by a bus as common connection.

5. The apparatus of claim 3, wherein
the control section includes
a voltage setting section configured to carry out voltage setting of a semiconductor device in accordance with an input designated by the input section, and
a device characteristic computation section configured to execute the modules on the basis of at least the voltage set by the voltage setting section, and compute the semiconductor device characteristics.

6. The apparatus of claim 1, wherein the scattering process is an ionized impurity scattering or elastic scattering.

7. The apparatus of claim 1, wherein in the second module configured to compute a drift process, the computation is carried out by assuming that a scattering occurs only after an elapse of the momentum relaxation time.

8. The device of claim 1, wherein a device simulation method to be executed by the device is executed with respect to an insulated-gate field-effect transistor provided with a source/drain region which is a high concentration impurity diffusion region.

9. A computer readable medium with a program which is executable by a computer in a semiconductor device simulation apparatus, the computer program controlling the computer to execute functions of:
computing a reciprocal of the momentum relaxation time with respect to a part which is processed as an anisotropic scattering process of a carrier, and computing the free-flight time by using the reciprocal of the momentum relaxation time;
computing a drift process of the carrier during the free-flight time; and
computing a scattering process by regarding a scattering after the drift process as an isotropic scattering, and by an output of the computing the drift process.

10. The medium of claim 9, further computing the time after the free-flight time.

11. The medium of claim 9, wherein the scattering process is an ionized impurity scattering or elastic scattering.

12. The medium of claim 9, wherein when computation of the drift process is carried out, the computation is carried out by assuming that a scattering occurs only after an elapse of the momentum relaxation time.

13. The medium of claim 9, wherein the computer program of the storage medium is executed with respect to an insulated-gate field-effect transistor provided with a source/drain region which is a high concentration impurity diffusion region.

14. A semiconductor simulation method using a semiconductor device simulation apparatus including an input section, control section, and computation section configured to compute the free-flight time, computation section configured to compute a drift process, and computation section configured to compute a scattering process which are controlled by the control section, comprising:
computing a reciprocal of the momentum relaxation time from an input value input from the input section with respect to a part which is processed as an anisotropic scattering process of a carrier, and computing the free-flight time by using the reciprocal of the momentum relaxation time;
computing a drift process of the carrier during the free-flight time; and
computing a scattering process by regarding a scattering after the drift process as an isotropic scattering, by an output of the computing the drift process.

15. The method of claim 14, further comprising computing the time after the free-flight time.

16. The method of claim 14, wherein the semiconductor device simulation apparatus further includes an output section electrically connected to the control section, for outputting a computation result.

17. The method of claim 14, wherein the semiconductor device simulation apparatus further includes a data storage section an output of which is connected to the input section by a bus as common connection.

18. The method of claim 14, wherein
the control section includes
a voltage setting section configured to carry out voltage setting of a semiconductor device in accordance with an input designated by the input section, and
a device characteristic computation section configured to execute a program on the basis of at least the voltage set by the voltage setting section, and computing the semiconductor device characteristics.

19. The method of claim 14, wherein the scattering process is an ionized impurity scattering or elastic scattering.

20. The method of claim 14, wherein in the computation of the drift process, the computation is carried out by assuming that a scattering occurs only after an elapse of the momentum relaxation time.
